(19) United States
(12) Patent Application Publication
(10) Pub. No.: US 2010/0045653 A1
(43) Pub. Date: Feb. 25, 2010

(54) PLASMA DISPLAY DEVICE

(76) Inventors: Dong Hyun PARK, Gumi-si (KR); Seok Ho Kim, Gumi-si (KR); Hyung Jae Kim, Gumi-si (KR)

Correspondence Address: KED & ASSOCIATES, LLP, P.O. Box 221200, Chantilly, VA, 20153-1200, US

(21) Appl. No.: 12/432,255

(22) Filed: Apr. 29, 2009

(30) Foreign Application Priority Data
Aug. 19, 2008 (KR) 10-2008-0081030

(51) Int. Cl. G06F 3/038; G09G 3/28

(52) U.S. Cl. 345/213; 345/60

(57) ABSTRACT

A plasma display device is provided. The plasma display device may include a plasma display panel (PDP) including an upper substrate having a plurality of scan electrodes and a plurality of sustain electrodes formed thereon and a lower substrate having a plurality of address electrodes formed thereon; and a driving unit applying a number of driving signals to the scan electrodes, the sustain electrodes and the address electrodes, wherein the scan electrodes are divided into two or more groups including first and second groups, at least one of a plurality of subfields includes a first scan period during which a scan signal is applied to the scan electrodes included in the first group, a second scan period during which a scan signal is applied to the scan electrodes included in the second group, and a setting period between the first and second scan periods, and the time of application of a first pulse to the sustain electrodes during the setting period is earlier than the time of application of a second pulse applied to the scan electrodes during the setting period.

This application claims priority from Korean Patent Application No. 10-2008-0081030 filed on Aug. 19, 2008 in the Korean Intellectual Property Office, the disclosure of which is incorporated herein by reference in its entirety.

### BACKGROUND OF THE INVENTION

1. Field of the Invention

The present invention relates to a plasma display device, and more particularly, to an apparatus for driving a plasma display panel (PDP).

2. Description of the Related Art

Plasma display devices include a panel having a rear substrate on which a plurality of barrier walls are formed, a front substrate facing the rear substrate, and a plurality of discharge cells formed between the rear substrate and the front substrate and display images by selectively discharging the discharge cells in response to an input image signal so as to generate vacuum ultraviolet (UV) rays and thus to cause phosphors to emit light.

In order to effectively display images, plasma display devices may also include a driving control device processing the input image signal and providing the processed image signal to a plurality of electrodes included in the panel as a driving signal.

However, large-scale plasma display devices generally have insufficient time margins for driving a panel. Therefore, it is necessary to drive the panels of plasma display devices at high speed.

### SUMMARY OF THE INVENTION

The present invention provides a plasma display device.

According to an aspect of the present invention, there is provided a plasma display device including a plasma display panel (PDP) including an upper substrate having a plurality of scan electrodes and a plurality of sustain electrodes formed thereon and a lower substrate having a plurality of address electrodes formed thereon; and a driving unit applying a number of driving signals to the scan electrodes, the sustain electrodes and the address electrodes, wherein the scan electrodes are divided into two or more groups including first and second groups, at least one of a plurality of subfields includes a first scan period during which a scan signal is applied to the scan electrodes included in the first group, a second scan period during which a scan signal is applied to the scan electrodes included in the second group, and a setting period between the first and second scan periods, and the time of application of a first pulse to the sustain electrodes for the first time during the setting period is earlier than the time of application of a second pulse applied to the scan electrodes for the first time during the setting period.

According to another aspect of the present invention, there is provided a plasma display device including a PDP including an upper substrate having a plurality of scan electrodes and a plurality of sustain electrodes formed thereon and a lower substrate having a plurality of address electrodes formed thereon; and a driving unit applying a number of driving signals to the scan electrodes, the sustain electrodes and the address electrodes, wherein the scan electrodes are divided into two or more groups including first and second groups, at least one of a plurality of subfields includes a first scan period during which a scan signal is applied to the scan electrodes included in the first group, a second scan period during which a scan signal is applied to the scan electrodes included in the second group, and a setting period between the first and second scan periods, and the setting period includes a first period during which a first voltage is applied to the sustain electrodes, a second period during which the sustain electrodes are maintained at the first voltage and a second voltage is applied to the scan electrodes, and a third period during which the scan electrodes are maintained at the second voltage.

### BRIEF DESCRIPTION OF THE DRAWINGS

The above and other features and advantages of the present invention will become more apparent by describing in detail preferred embodiments thereof with reference to the attached drawings in which:

FIG. 1 illustrates a perspective view of a plasma display panel (PDP) according to an exemplary embodiment of the present invention;

FIG. 2 illustrates a cross-sectional view for explaining the arrangement of electrodes in a PDP;

FIG. 3 illustrates a timing diagram for explaining a time-division method of driving a PDP in which a frame is divided into a plurality of subfields;

FIG. 4 illustrates a timing diagram of a plurality of driving signals for driving a PDP;

FIG. 5 illustrates a timing diagram of a plurality of driving signals for driving a plasma display device according to an exemplary embodiment of the present invention, in which a plurality of scan electrodes of a PDP are divided into two groups and are driven in units of the two groups;

FIG. 6 illustrates a timing diagram of a plurality of driving signals for driving a plasma display device according to another exemplary embodiment of the present invention, in which a plurality of scan electrodes of a PDP are divided into two groups and are driven in units of the two groups;

FIG. 7 illustrates a detailed timing diagram of the driving signals applied during a second subfield shown in FIG. 6;

FIG. 8 illustrates a timing diagram of a plurality of driving signals for driving a plasma display device according to another exemplary embodiment of the present invention, in which a plurality of scan electrodes of a PDP are divided into two groups and are driven in units of the two groups;

FIG. 9 illustrates a detailed timing diagram of the driving signals applied during a second subfield shown in FIG. 8;

FIGS. 10 through 12 illustrate diagrams showing variations in the wall-charge state of scan electrodes throughout the second subfield shown in FIG. 9.

FIG. 13 illustrates a timing diagram of a plurality of driving signals for driving a plasma display device according to another exemplary embodiment of the present invention, in which a plurality of scan electrodes of a PDP are divided into two groups and are driven in units of the two groups.

### DETAILED DESCRIPTION OF THE INVENTION

The present invention will hereinafter be described in detail with reference to the accompanying drawings in which exemplary embodiments of the invention are shown.

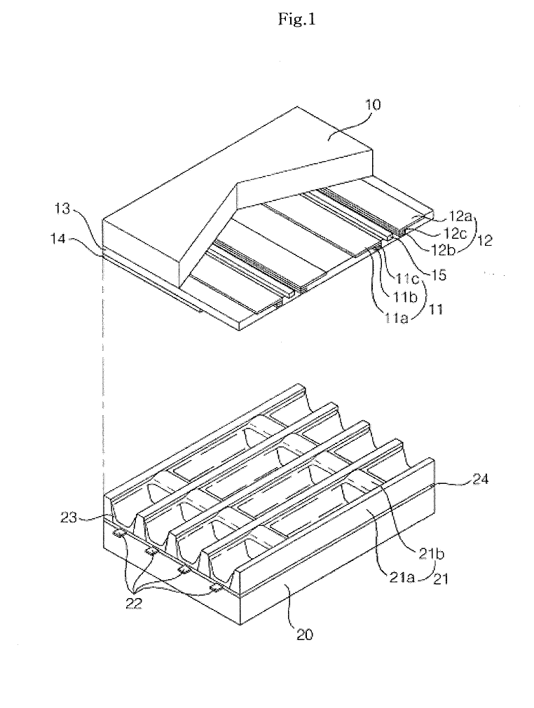

FIG. 1 illustrates a perspective view of a plasma display panel according to an exemplary embodiment of the present invention. Referring to FIG. 1, the PDP includes an upper substrate 10, a plurality of electrode pairs which are formed on the upper substrate 10 and consist of a scan electrode 11 and a sustain electrode 12 each; a lower substrate 20; and a plurality of address electrodes 22 which are formed on the lower substrate 20.

Each of the electrode pairs includes transparent electrodes 11a and 12a and bus electrodes 11b and 12b. The transparent electrodes 11a and 12a may be formed of indium-tin-oxide (ITO). The bus electrodes 11b and 12b may be formed of a metal such as silver (Ag) or chromium (Cr) or may include a stack of chromium/copper/chromium (Cr/Cu/Cr) or a stack of chromium/aluminium/chromium (Cr/Al/Cr). The bus electrodes 11b and 12b are respectively formed on the transparent electrodes 11a and 12a and reduce a voltage drop caused by the transparent electrodes 11a and 12a which have a high resistance.

Each of the electrode pairs may include the bus electrodes 11b and 12b only. In this case, the manufacturing cost of the PDP can be reduced by not using the transparent electrodes 11a and 12a. The bus electrodes 11b and 12b may be formed of various materials other than those set forth herein, e.g., a photosensitive material.

Black matrices are formed on the upper substrate 10. The black matrices perform a light shied function by absorbing external light incident upon the upper substrate 10 so that light reflection can be reduced. In addition, the black matrices enhance the purity and contrast of the upper substrate 10.

More specifically, the black matrices include a first black matrix 15 which overlaps a plurality of barrier ribs 21, a second black matrix 11c which is formed between the transparent electrode 11a and the bus electrode 11b of each of the scan electrodes 11, and a second black matrix 12c which is formed between the transparent electrode 12a and the bus electrode 12b. The first black matrix 15 and the second black matrices 11c and 12c, which can also be referred to as black layers or black electrode layers, may be formed at the same time and may be physically connected. Alternatively, the first black matrix 15 and the second black matrices 11c and 12c may not be formed at the same time, and may not be physically connected.

If the first black matrix 15 and the second black matrices 11c and 12c are physically connected, the first black matrix 15 and the second black matrices 11c and 12c may be formed of the same material. On the other hand, if the first black matrix 15 and the second black matrices 11c and 12c are physically separated, the first black matrix 15 and the second black matrices 11c and 12c may be formed of different materials.

An upper dielectric layer 13 and a passivation layer 14 are deposited on the upper substrate 10 on which the scan electrodes 11 and the sustain electrodes 12 are formed in parallel with one other. Charged particles generated as a result of a discharge accumulate in the upper dielectric layer 13. The upper dielectric layer 13 may protect the electrode pairs. The passivation layer 14 protects the upper dielectric layer 13 from sputtering of the charged particles and enhances the discharge of secondary electrons.

The address electrodes 22 are formed and intersects the scan electrode 11 and the sustain electrodes 12. A lower dielectric layer 24 and the barrier ribs 21 are formed on the lower substrate 20 on which the address electrodes 22 are formed.

A phosphor layer is formed on the lower dielectric layer 24 and the barrier ribs 21. The barrier ribs 21 include a plurality of vertical barrier ribs 21a and a plurality of horizontal barrier ribs 21b that form a closed-type barrier rib structure. The barrier ribs 21 define a plurality of discharge cells and prevent ultraviolet (UV) rays and visible rays generated by a discharge from leaking into the discharge cells.

The present invention can be applied to various barrier rib structures, other than that set forth herein. For example, the present invention can be applied to a differential barrier rib structure in which the height of vertical barrier ribs 21a is different from the height of horizontal barrier ribs 21b, a channel-type barrier rib structure in which a channel that can be used as an exhaust passage is formed in at least one vertical or horizontal barrier rib 21a or 21b, and a hollow-type barrier rib structure in which a hollow is formed in at least one vertical or horizontal barrier rib 21a or 21b. In the differential barrier rib structure, the height of horizontal barrier ribs 21b may be greater than the height of vertical barrier ribs 21a. In the channel-type barrier rib structure or the hollow-type barrier rib structure, a channel or a hollow may be formed in at least one horizontal barrier rib 21b.

Red (R), green (G), and blue (B) discharge cells are arranged in a straight line. However, the present invention is not restricted to this. For example, R, G, and B discharge cells may be arranged as a triangle or a delta. Alternatively, R, G, and B discharge cells may be arranged as a polygon such as a rectangle, a pentagon, or a hexagon.

The phosphor layer is excited by UV rays that are generated upon a gas discharge. As a result, the phosphor layer generates one of R, G, and B rays. A discharge space is provided between the upper and lower substrates 10 and 20 and the barrier ribs 21. A mixture of inert gases, e.g., a mixture of helium (He) and xenon (Xe), a mixture of neon (Ne) and Xe, or a mixture of He, Ne, and Xe is injected into the discharge space.

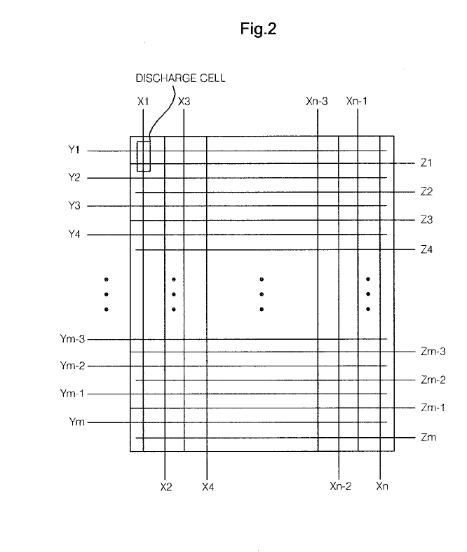

FIG. 2 illustrates the arrangement of electrodes in a PDP. Referring to FIG. 2, a plurality of discharge cells that constitute a PDP may be arranged in a matrix. The discharge cells are respectively disposed at the intersections between a plurality of scan electrode lines Y₁ through Yₘ and a plurality of address electrode lines X₁ through Xₙ or the intersections between a plurality of sustain electrode lines Z₁ through Zₘ and the address electrode lines X₁ through Xₙ. The scan electrode lines Y₁ through Yₘ may be sequentially or simultaneously driven. The sustain electrode lines Z₁ through Zₘ may be simultaneously driven. The address electrode lines X₁ through Xₙ may be divided into two groups: a group including odd-numbered address electrode lines and a group including even-numbered address electrode lines. The address electrode lines X₁ through Xₙ may be driven in units of the groups or may be sequentially driven.

The electrode arrangement illustrated in FIG. 2, however, is exemplary, and thus, the present invention is not restricted to this. For example, the scan electrode lines Y₁ through Yₘ may be driven using a dual scan method in which two of a plurality of scan lines are driven at the same time. The address electrode lines X₁ through Xₙ may be divided into two groups: a group including a number of upper address electrode lines disposed in the upper half of a PDP and a group including a number of lower address electrode lines disposed in the lower half of the PDP or a group including a number of address electrode lines disposed in the left half of the PDP and a group including a number of address electrode lines disposed in the right half of the PDP. Then, the address electrode lines X₁ through Xₙ may be driven in units of the two groups.

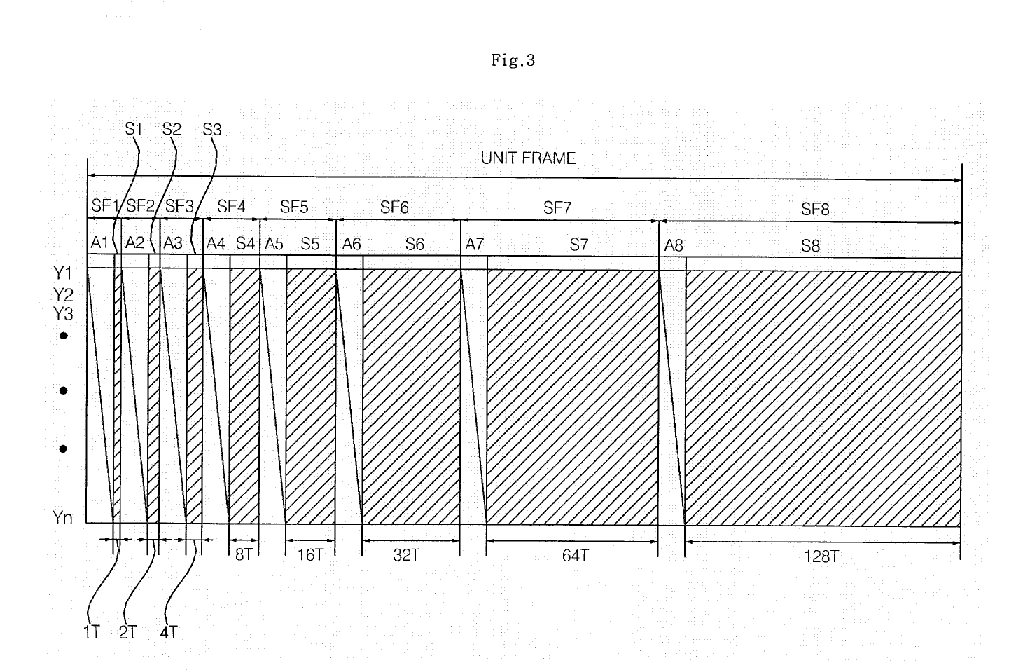

FIG. 3 illustrates a timing diagram for explaining a time-division method of driving a PDP in which a frame is divided into a plurality of subfields. Referring to FIG. 3, a unit frame is divided into a predefined number of subfields, for example, eight subfields SF1 through SF8, in order to realize a time-division grayscale display. Each of the subfields SF1 through SF8 is divided into a reset period (not shown), an address period (A1, . . . , A8), and a sustain period (S1, . . . , S8).

Not all of the subfields SF1 through SF8 may have a reset period. For example, only the first subfield SF1 may have a reset period, or only the first subfield and a middle subfield may have a reset period.

During each of the address periods A1 through A8, a display data signal is applied to an address electrode X, and a scan pulse is applied to a scan electrode Y so that wall charges can be generated in a discharge cell.

During each of the sustain periods S1 through S8, a sustain pulse is alternately applied to the scan electrode Y and a sustain electrode Z so that a discharge cell can cause a number of sustain discharges.

The luminance of a PDP is proportional to the total number of sustain discharge pulses allocated throughout the sustain discharge periods S1 through S8. Assuming that a frame for one image includes eight subfields and is represented with 256 grayscale levels, 1, 2, 4, 8, 16, 32, 64, and 128 sustain pulses may be respectively allocated to the sustain periods S1, S2, S3, S4, S5, S6, S7, and S8. In order to realize a grayscale level of 133, a plurality of discharge cells may be addressed during the first, third, and eighth subfields SF1, SF3, and SF8 so that they can cause a total of 133 sustain discharges.

The number of sustain discharges allocated to each of the subfields SF1 through SF8 may be determined according to a weight allocated to a corresponding subfield through automatic power control (APC). Referring to FIG. 3, a frame is divided into eight subfields, but the present invention is not restricted to this. In other words, the number of subfields in a frame may be varied. For example, a PDP may be driven by dividing each frame into more than eight subfields (e.g., twelve or sixteen subfields).

The number of sustain discharges allocated to each of the subfields SF1 through SF8 may be varied according to gamma and other characteristics of a PDP. For example, a grayscale level of 6, instead of a grayscale level of 8, may be allocated to the subfield SF4, and a grayscale level of 34, instead of a grayscale level of 32, may be allocated to the subfield SF6.

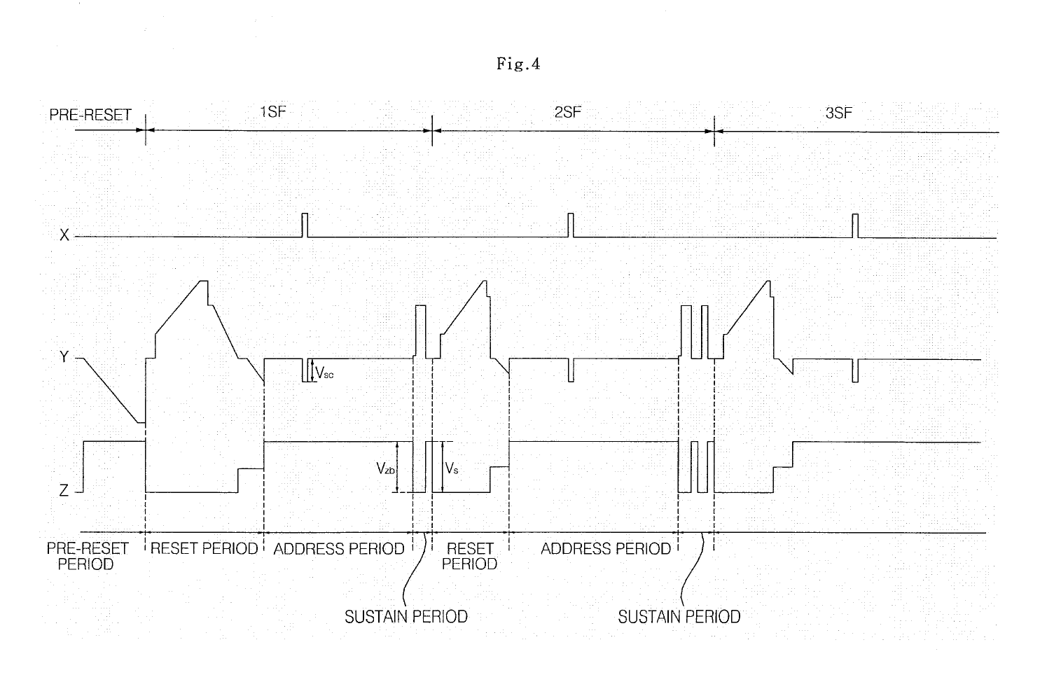

FIG. 4 illustrates a timing diagram of a plurality of driving signals for driving a PDP, according to an embodiment of the present invention. Referring to FIG. 4, a pre-reset period is followed by a first subfield. During the pre-reset period, positive wall charges are generated on scan electrodes Y and negative wall charges are generated on sustain electrodes Z. A subfield may include a reset period for initializing the discharge cells of a previous frame with reference to the distribution of wall charges generated during the pre-reset period, an address period for selecting a number of discharge cells, and a sustain period for enabling the selected discharge cells to cause a number of sustain discharges.

A reset period may include a set-up period during and a set-down period. During a set-up period, a ramp-up waveform is applied to all the scan electrodes Y at the same time so that all discharge cells each can cause a weak discharge, and that wall charges can be generated in the discharge cells, respectively.

During a set-down period, a ramp-down waveform whose voltage decreases from a positive voltage that is lower than a peak voltage of the ramp-up waveform is applied to all the scan electrodes Y so that each of the discharge cells can cause an erase discharge, and that whichever of the wall charges generated during the set-up period and space charges are unnecessary can be erased.

During an address period, a scan signal having a negative scan voltage Vsc may be sequentially applied to the scan electrodes Y while applying a positive data signal to the address electrodes X. Due to the difference between the scan signal and the data signal and the wall charges generated during the reset period, an address discharge occurs, and a cell is selected. In order to improve the efficiency of an address discharge, a sustain bias voltage Vzb may be applied to the sustain electrodes Z during an address period.

During an address period, the scan electrodes Y may be divided into two or more groups, and a scan signal may be sequentially applied to each of the groups. Each of the groups may be divided into two or more sub-groups, and a scan signal may be sequentially applied to each of the sub-groups. For example, the scan electrodes Y may be divided into a first group and a second group. Then, a scan signal may be sequentially applied to a number of scan electrodes Y included in the first group. Thereafter, a scan signal may be sequentially applied to a number of scan electrodes Y included in the second group.

More specifically, the scan electrodes Y may be divided into a first group including a plurality of even-numbered scan electrodes Y and a second group including a plurality of odd-numbered scan electrodes Y. Alternatively, the scan electrodes Y may be divided into a first group including a plurality of upper scan electrodes Y and a second group including a plurality of lower scan electrodes Y.

Once the scan electrodes Y are divided into first and second groups, each of the first and second groups may be divided into a first sub-group including a plurality of even-numbered scan electrodes Y and a second sub-group including a plurality of odd-numbered scan electrodes Y or a first sub-group including a plurality of upper scan electrodes Y and a second sub-group including a plurality of lower scan electrodes Y.

During a sustain period, a sustain pulse is alternately applied to the scan electrodes Y and the sustain electrodes Z so that surface discharges can occur between the scan electrodes Y and the respective sustain electrodes Z as sustain discharges.

Of a plurality of sustain pulses alternately applied to the scan electrodes Y and the sustain electrodes Z, the first or last sustain pulse may have a larger width than the other sustain pulses.

A subfield may also include an erase period following a sustain period. During an erase period, wall charges remained in the scan electrodes Y or the sustain electrodes Z of discharge cells (i.e., on-cells) selected during an address period may be removed by causing a weak discharge after a sustain discharge.

All or only some of first through eighth subfields may include an erase period. During an erase period, an erase signal for causing a weak discharge may be applied to electrodes to which the last one of a plurality of sustain pulses applied during a sustain period is not applied.

A ramp-type signal, a low-voltage wide pulse, a high-voltage narrow pulse, a exponential signal or a half-sinusoidal pulse may be used as an erase signal.

In order to cause a weak discharge, a plurality of pulses may be sequentially applied to the scan electrodes Y or the sustain electrodes Z.

The waveforms illustrated in FIG. 4 are exemplary, and thus, the present invention is not restricted thereto. For example, the pre-reset period may be optional. In addition, the polarities and voltages of driving signals used to drive a PDP are not restricted to those illustrated in FIG. 4, and may be altered in various manners. An erase signal for erasing wall charges may be applied to each of the sustain electrodes Z after a sustain discharge. The sustain signal may be applied to either the scan electrodes Y or the sustain electrodes Z, thereby realizing a single-sustain driving method.

The scan electrodes Y may be divided into two or more groups and may thus be driven in units of the groups.

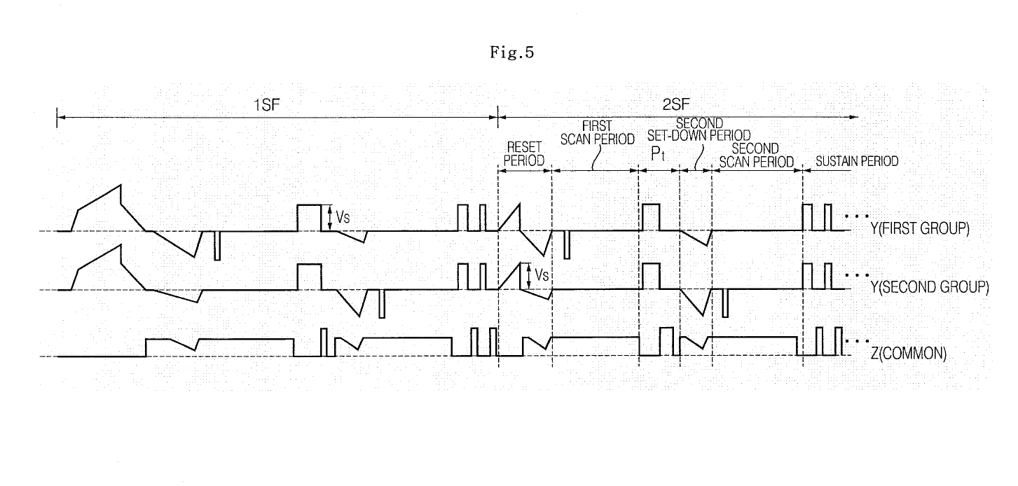

FIG. 5 illustrates a timing diagram of a plurality of driving signals for driving a plasma display device according to an exemplary embodiment of the present invention, in which a plurality of scan electrodes of a PDP are divided into two groups (i.e., a first group including a number of even-numbered scan electrodes and a second group including a number of odd-numbered scan electrodes) and are driven in units of the groups. Referring to FIG. 5, a second subfield 2SF may include a reset period, a setting period Pₜ, a sustain period and a plurality of first and second scan periods and a second set-down period.

A reset period is a time period for initializing the wall-charge state of all the scan electrodes included in the first or second group.

During the first scan period, a scan pulse may be applied to discharge cells of the scan electrodes included in the first group. Then, a data pulse may be applied to a plurality of address electrodes, and thus, an address operation may be performed. Therefore, a number of cells to be turned on may be chosen from the scan electrodes included in the first group. During the setting period Pₜ, which follows the first scan period, a sustain discharge may occur in the cells chosen during the first scan period

The second subfield 2SF may also include the second set-down period for removing unnecessary wall charges.

During the second scan period, which follows the second se-down period, a scan pulse may be applied to discharge cells of the scan electrodes included in the second group. Then, a data pulse may be applied to the address electrodes, and thus, an address operation may be performed. Therefore, a number of cells to be turned on may be chosen from the scan electrodes included in the second group. The sustain period, which follows the second scan period, may include a time period for causing a predefined number of sustain discharges in a plurality of cells to be turned on after the occurrence of a sustain discharge in the scan electrodes included in the second group.

An address operation and a sustain discharge operation for the first group may be performed, and then an address operation and a sustain discharge operation for the second group may be performed. Then, it is possible to reduce the time required to complete an address operation and a sustain discharge operation, compared to the case of performing an address operation on all the scan electrodes and then performing a sustain discharge operation on all the scan electrodes. Therefore, it is possible to minimize the time gap between the address period and the sustain period and thus to smoothly perform a sustain discharge operation during the sustain period.

Once a weak discharge occurs during the reset period, no discharge may occur in the scan electrodes included in the second group until the arrival of the setting period Pₜ. Therefore, it is necessary to maintain the wall charges generated during the reset period until the arrival of the second scan period. However, since some wall charges tend to be lost over time, an address discharge operation for the second group may become unstable due to a shortage of wall charges.

In addition, during the reset period, a ramp-type set-up signal whose voltage gradually increases may be applied. Since it generally takes time to increase the voltage of the set-up signal, the set-up period may continue for more than 200 μs, thereby resulting in an insufficient timing margin.

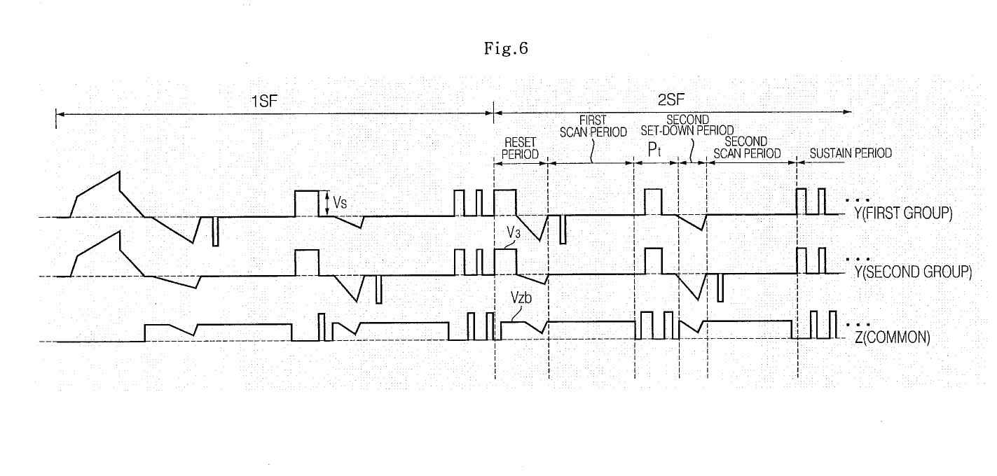

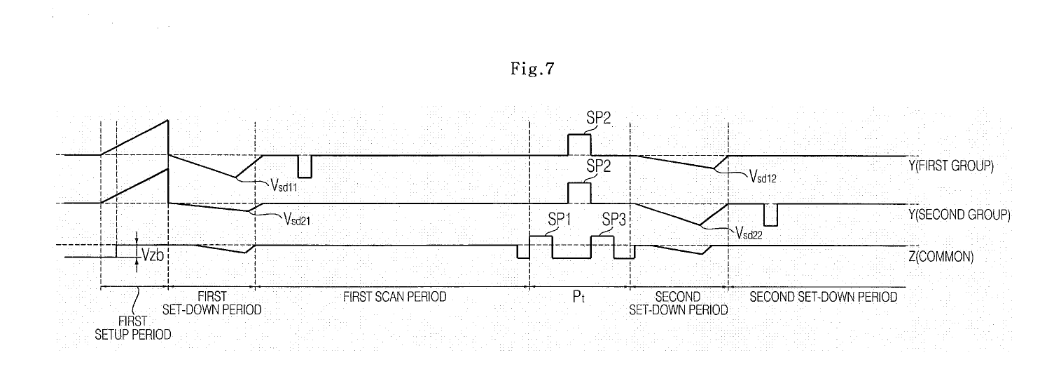

FIGS. 6 and 7 illustrate timing diagrams of a plasma display device according to another exemplary embodiment of the present invention, in which a plurality of scan electrodes of a PDP are divided into two groups and are driven in units of the groups. Referring to FIGS. 6 and 7, a plurality of scan electrodes may be divided into two or more groups including first and second groups.

More specifically, the plasma display device of the exemplary embodiment of FIGS. 6 and 7 may include a PDP including a plurality of scan electrodes formed on an upper substrate, a plurality of sustain electrodes formed on the upper substrate, and a plurality of address electrodes formed on a lower substrate and a driving unit applying a number of driving signals to the scan electrodes, the sustain electrodes and the address electrodes.

The scan electrodes may be divided into two or more groups including first and second groups. At least one of a plurality of subfields may include a first scan period during which a scan signal is applied to the scan electrodes included in the first group, a second scan period during which a scan signal is applied to the scan electrodes included in the second group, and a setting period Pₜ between the first and second scan periods.

During the setting period Pₜ, the time of application of a first pulse SP1 to the sustain electrodes may be earlier than the time of application of a second pulse SP2 to the scan electrodes.

The first group may include a number of even-numbered scan electrodes, and the second group may include a number of odd-numbered scan electrodes.

Alternatively, the first group may include a number of upper electrodes disposed in the upper half of the PDP, and the second group may include a number of lower electrodes disposed in the lower half of the PDP.

The driving signal provided by the driving unit may be applied during at least one of a plurality of subfields, for example, a second subfield 2SF shown in FIG. 6.

Referring to FIG. 6, the second subfield 2SF may include the first scan period during which a scan signal is applied to the scan electrodes included in the first group, the second scan period during which a scan signal is applied to the scan electrodes included in the second group, and the setting period Pₜ between the first and second scan periods. The second subfield 2SF may also include a second set-down period.

A maximum voltage detected during the set-up period of a first subfield 1SF may be higher than a maximum voltage detected during the set-up period of the second subfield 2SF. During the first subfield 1SF, it is necessary to cause a strong reset discharge for forming wall charges. However, any subfield subsequent to the second subfield 2SF may benefit from a priming effect caused by a sustain discharge operation performed in its previous field. Therefore, it is possible to apply a lower reset voltage during the reset periods of the second through eighth subfields 2SF through 8SF than during the reset period of the first subfield 1SF.

FIG. 7 illustrates a detailed timing diagram of the driving signals applied during the second subfield 2SF shown in FIG. 6. Referring to FIG. 7, during the first scan period, neither a scan signal nor a data signal is applied to the scan electrodes included in the second group, and thus, no address discharge may occur. Positive wall charges may be generated in the sustain electrodes, and negative wall charges may be generated in the scan electrodes included in the second group. Some of the positive or negative wall charges may be lost over time. Since it generally takes more time to cause an address discharge in the scan electrodes included in the second group than to cause an address discharge in the scan electrodes included in the first group after a reset discharge, an address misdischarge may become more likely to occur if a considerable amount of wall charge is lost over time.

During the setting period Pₜ, a positive first pulse may be applied to the sustain electrodes, whereas no voltage is applied to the scan electrodes and the address electrodes. The level of the first pulse may be the same as a sustain voltage. In this case, an additional power supply circuit is unnecessary, and thus, it is easy to design circuitry.

During the setting period Pₜ, a weak discharge may occur in the scan electrodes included in the second group due to a voltage applied only to the sustain electrodes and positive wall charges generated in the sustain electrodes.

It is necessary to maintain the wall charges generated during the reset period until the arrival of the second scan period. However, if no discharge occurs in the scan electrodes included in the second group until the arrival of the setting period Pₜ, it may become almost impossible to maintain the same wall-charge state as that during the reset period until the arrival of the second scan period without any wall charge loss due to a long interval between the reset period and the second scan period. Thus, an address discharge operation for the scan electrodes included in the second group may become unstable due to a shortage of wall charges.

However, if a weak discharge is induced to occur in the scan electrodes included in the second group, as described above, almost the same wall-charge state as that obtained after the reset period may be uniformly maintained until the arrival of the second set-down period or even the scan period for causing an address discharge in the scan electrodes included in the second group. Therefore, it is possible to prevent the occurrence of an address misdischarge.

In short, during the setting period Pₜ, a sustain discharge may occur in the scan electrodes included in the first group, and a weak discharge similar to a setup discharge may occur in the scan electrodes included in the second group.

In this case, since it is undesirable to induce too strong a discharge or induce a discharge for too long with the use of the first pulse SP1 in terms of timing margin, the width of the first pulse SP1 may be set to be about 1 μs.

In order to facilitate the design of circuitry, the voltage of the first pulse SP1 may be set to be the same as the voltage of the second pulse SP2. In addition, the duration of application of the first pulse SP1 may partially overlap with the duration of application of the second pulse SP2.

The number of pulses applied to the sustain electrodes during the setting period Pₜ may be different from the number of pulses applied to the scan electrodes during the setting period Pₜ. More specifically, referring to FIG. 7, the number of pulses applied to the sustain electrodes during the setting period Pₜ may be one greater than the number of pulses applied to the scan electrodes during the setting period Pₜ.

During the setting period Pₜ, the first pulse SP1 may cause a weak discharge in the scan electrodes included in the second group, and the second and third pulses SP2 and SP3 may cause a pair of sustain discharges (OK?) in the scan electrodes included in the first group. If a sustain discharge operation is performed during the setting period Pₜ, it is possible to reduce the time required to complete an address operation and a sustain discharge operation, compared to the case of performing an address operation on all the scan electrodes and then performing a sustain discharge operation on all the scan electrodes.

In addition, during the setting period Pₜ, a plurality of pairs of pulses may be applied. Thus, it is possible to generate more than one sustain discharge.

During the second set-down period following the setting period Pₜ, a second set-down signal whose voltage gradually decreases may be applied to each of the first group and the second group. In this case, the slope of the second set-down signal applied to the first group may be greater than the slope of the second set-down signal applied to the second group. Since an address operation is performed on the scan electrodes included in the second group during the second scan period, a second set-down signal whose voltage gradually decreases almost until the arrival of the second scan period may be applied to the scan electrodes included in the second group, and thus, the wall charges in the scan electrodes included in the second group may be uniformly maintained. Therefore, it is possible to maintain an appropriate wall-charge state for smoothly inducing an address discharge. The voltage of the scan electrodes included in the first group may be gradually reduced by floating the scan electrodes included in the first group.

In another exemplary embodiment of the present invention, the reset period may include a first set-up period during which a reset signal applied to the scan electrodes is maintained at a positive voltage and a first set-down period during which the voltage of the reset signal gradually decreases from the positive voltage to a negative voltage. A bias voltage Vzb may be applied to the sustain electrodes. The duration of application of the bias voltage Vzb may at least partially overlap with the duration of application of the reset signal. During the first set-down period, the scan electrodes included in the second group may be floated so that the voltage of the scan electrodes included in the second group can gradually decrease.

An address discharge occurs in the scan electrodes included in the second group later than in the scan electrodes included in the first group. Thus, in order to reduce the amount of wall charge lost over time and retain as much wall charge as possible, the absolute value of a minimum voltage Vsd11 of the voltages of the scan electrodes included in the first group during the first set-down period may be set to be greater than the absolute value of a minimum voltage Vsd21 of the voltages of the scan electrodes included in the second group during the first set-down period.

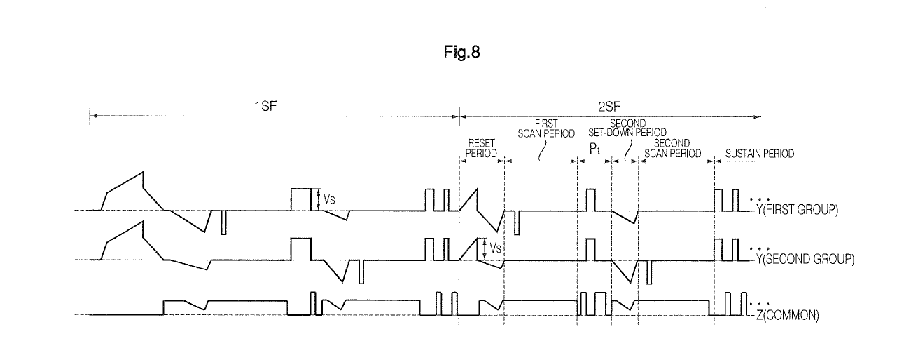

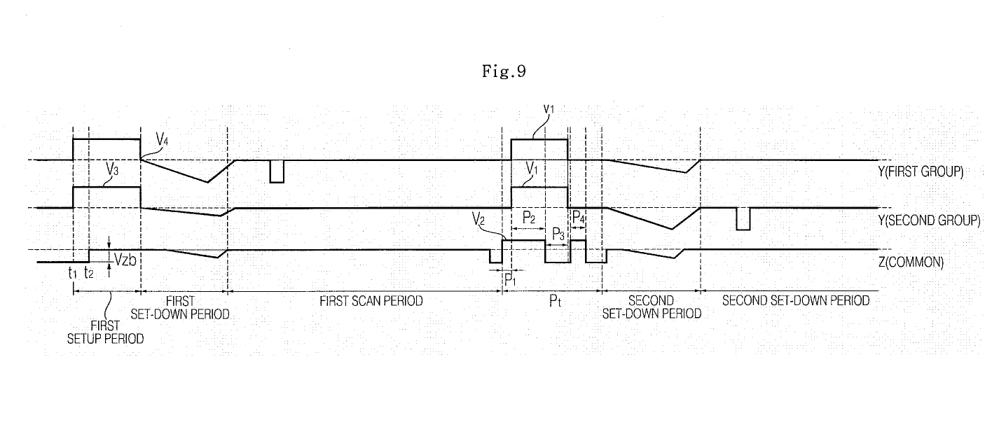

FIGS. 8 and 9 illustrate timing diagrams of a plasma display device according to another exemplary embodiment of the present invention, in which a plurality of scan electrodes of a PDP are divided into two groups and are driven in units of the groups. The plasma display device of the exemplary embodiment of FIGS. 8 and 9 may include a PDP including a plurality of scan electrodes formed on an upper substrate, a plurality of sustain electrodes formed on the upper substrate, and a plurality of address electrodes formed on a lower substrate and a driving unit applying a number of driving signals to the scan electrodes, the sustain electrodes and the address electrodes.

The scan electrodes may be divided into two or more groups including first and second groups. At least one of a plurality of subfields may include a first scan period during which a scan signal is applied to the scan electrodes included in the first group, a second scan period during which a scan signal is applied to the scan electrodes included in the second group, and a setting period Pₜ between the first and second scan periods.

The setting period Pₜ may include a first period P₁ during which a first voltage is applied to the sustain electrodes, a second period P₂ during which a second voltage is applied to the scan electrodes while maintaining the sustain electrodes at the first voltage, and a third period P₃ during which the scan electrodes are maintained at the second voltage.

The first group may include a number of even-numbered scan electrodes, and the second group may include a number of odd-numbered scan electrodes.

Alternatively, the first group may include a number of upper electrodes disposed in the upper half of the PDP, and the second group may include a number of lower electrodes disposed in the lower half of the PDP.

The driving signal provided by the driving unit may be applied during at least one of a plurality of subfields, for example, a second subfield 2SF shown in FIG. 8.

Referring to FIG. 8, the second subfield 2SF may include a first scan period during which a scan signal is applied to the scan electrodes included in the first group, a second period during which a scan signal is applied to the scan electrodes included in the second group, a setting period Pₜ between the first and second scan periods, and a second set-down period.

FIG. 9 illustrates a detailed timing diagram of the driving signals applied during the second subfield 2SF shown in FIG. 8.

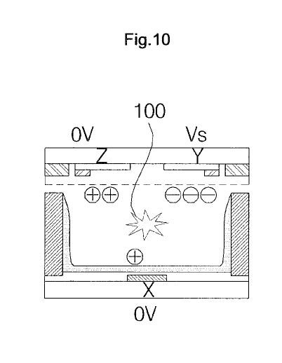

FIGS. 10 through 12(e) illustrate diagrams showing variations in the wall-charge state of the scan electrodes of a plasma display device throughout the second subfield 2SF shown in FIG. 9. The variations in the wall-charge state of the scan electrodes of a plasma display device during the second subfield 2SF shown in FIG. 7 are almost the same as the variations in the wall-charge state of the scan electrodes of a plasma display device during the second subfield 2SF shown in FIG. 9.

Referring to FIGS. 9 through 12, during a first set-up period, a positive voltage may be applied to all the scan electrodes, and thus, a setup discharge may occur. As a result, wall charges may accumulate in the scan electrodes. FIG. 10 illustrates a diagram showing the wall-charge state of the scan electrodes during the first setup period.

The reset period during which a reset signal is applied to the scan electrodes may include the first setup period during which the reset signal is maintained at a third voltage and a first set-down period during which the voltage of the reset signal drops to a fourth voltage and then gradually decreases from the fourth voltage to a negative voltage. During the reset period, a bias voltage Vzb may be applied to the sustain electrodes. The duration of application of the bias voltage Vzb may at least partially overlap with the duration of application of the reset signal.

During the first set-down period, a signal whose voltage gradually decreases to a negative voltage may be applied to the scan electrodes, and thus, unnecessary wall charges may be removed from the scan electrodes.

More specifically, during the first set-down period, a signal whose voltage gradually decreases may be applied to the scan electrodes, and the positive bias voltage Vzb may be applied to the sustain electrodes. Thus, a weak discharge may occur between the scan electrodes and the sustain electrodes. As a result of the weak discharge, unnecessary wall charges may be removed from the scan electrodes.

Any subfield subsequent to the second subfield 2SF may benefit from a wall-charge state established by a sustain discharge performed in its previous subfield. In this case, the interval between the time of application of the reset signal to the scan electrodes, i.e., a time t1, and the time of application of the bias voltage Vzb to the sustain electrodes, i.e., a time t2, may be shorter than the third period. If the interval between the time t1 and the time t2 is longer than the third period, a time period for maintaining the sustain electrodes at a ground voltage while maintaining the scan electrodes at the third voltage may be too much prolonged. In this case, a strong discharge may occur between the scan electrodes and the sustain electrodes, and thus the wall-charge state of the scan electrodes may become unstable.

More specifically, the interval between the time t1 and the time t2 may be 1 μs or less. In this case, the length of the first setup period may be 10 μs or less. Thus, it is possible to secure a sufficient timing margin and thus to effectively drive a plasma display device at high speed.

During the first set-down period, the scan electrodes included in the second group may be floated so that the voltage of the scan electrodes included in the second group can gradually decrease. In addition, in order to facilitate the design of circuitry, a sustain voltage may be used as the third voltage, and the ground voltage may be used as the fourth voltage.

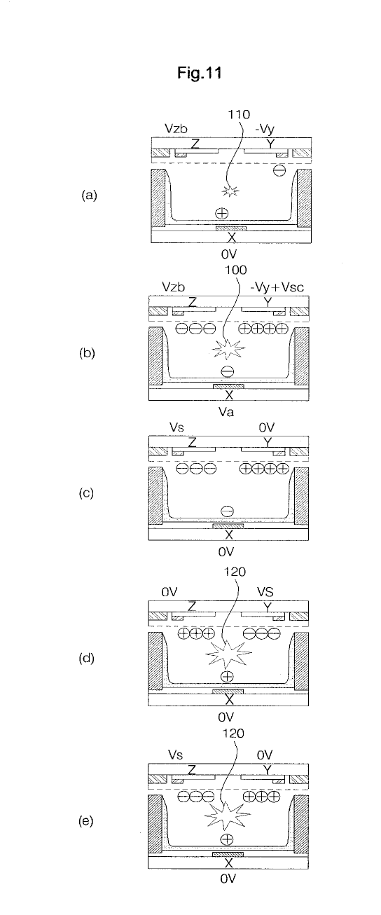

A driving signal applied to the scan electrodes included in the first group will hereinafter be described in detail with reference to FIGS. 11(a) through 11(e). FIGS. 11(a) through 11(e) illustrate diagrams showing the wall-charge state of the scan electrodes included in the first group during the second subfield 2SF shown in FIG. 9. Referring to FIG. 11(a), during the first set-down period, the voltage of the scan electrodes included in the first group may be gradually reduced to a negative voltage −Vy, thereby causing a weak discharge 110. As a result of the weak discharge 110, unnecessary wall charges may be removed from the scan electrodes included in the first group. The voltage of the scan electrodes included in the first group may be gradually reduced to the negative voltage −Vy in various manners. However (OK???), the voltage of the scan electrodes included in the first group may not necessarily be reduced to the negative voltage −Vy.

During the reset period, negative charges for causing an address discharge may be generated in the scan electrodes included in the first group. During the first scan period, a negative scan signal may be sequentially applied to the scan electrodes included in the first group while maintaining the voltage of the scan electrodes included in the first group at a scan bias voltage, and at the same time, a positive data signal Va may be applied to the address electrodes. As a result, an address discharge may occur.

FIG. 11(b) illustrates a diagram showing the wall-charge state of the scan electrodes included in the first group during the first scan period. Referring to FIG. 11(b), a discharge 100 may occur due to the difference between a negative scan signal applied to the scan electrodes included in the first group and a positive data signal applied to the address electrodes and a wall voltage generated during the reset period. As a result of the discharge 100, a number of cells to be turned on may be chosen. The voltage of the negative scan signal may be the same as the sum of a scan voltage Vsc and the negative voltage −Vy. For example, a scan signal having the negative voltage −Vy may be applied to the scan electrodes included in the first group while maintaining the voltage of the scan electrodes included in the first group at a voltage obtained by adding up the scan voltage Vsc and the negative voltage −Vy.

During the first scan period, the sustain electrodes may be maintained at a sustain bias voltage Vzb, thereby preventing the occurrence of a misdischarge between the sustain electrodes and the other electrodes. The sustain bias voltage Vzb may be applied to the sustain electrodes before the arrival of the first scan period.

The setting period Pₜ may include the first period P₁ during which a first voltage is applied to the sustain electrodes, the second period P₂ during which a second voltage is applied to the scan electrodes while maintaining the sustain electrodes at the first voltage, and the third period P₃ during which the scan electrodes are maintained at the second voltage.

FIG. 11(c) illustrates a diagram showing the wall-charge state of the scan electrodes included in the first group during the first period P₁. The wall-charge state of the scan electrodes included in the first group during the first period P₁ may be almost the same as the wall-charge state shown in FIG. 11(b) except that a positive first voltage is applied to the sustain electrodes while applying no voltage to the scan electrodes and the address electrodes. The first voltage may be a sustain voltage. Since no additional power supply circuit is provided, it is easy to design circuitry. Since a voltage is applied only to the sustain electrodes, it is impossible to achieve a firing voltage, which is a sufficient voltage to initiate a discharge, due to the wall charges having the opposite polarity to that of the voltage applied to the sustain electrodes. Therefore, during the first period P₁, no discharge may occur in the scan electrodes included in the first group.

During the second period P2, the sustain electrodes may be maintained at the first voltage, and a second voltage may be applied to the scan electrodes included in the first group. More specifically, during the second period P2, a positive voltage may be applied to the sustain electrodes and the scan electrodes included in the first group. In order to secure a sufficient driving timing margin, the second period P2 may be set to be short. The first voltage may be the sustain voltage. In this case, it is unnecessary to provide any additional power supply circuit. Thus, it is possible to facilitate the design of circuitry.

The third period P₃ may follow the second period P2. During the third period P₃, the scan electrodes included in the first group may be maintained at the second voltage, and a ground voltage may be applied to the sustain electrodes. FIG. 11(d) illustrates a diagram showing the wall-charge state of the scan electrodes included in the first group during the third period P₃. The wall-charge state of the scan electrodes included in the first group during the third period P₃ may be almost the same as the wall-charge state shown in FIG. 11(b) except that a positive first voltage is applied to the scan electrodes while applying no voltage to the sustain electrodes and the address electrodes. Referring to FIG. 11(d), during the third period P₃, the sum of the wall charges accumulated in the scan electrodes included in the first group and an external voltage applied to the scan electrodes included in the first group may be high enough to initiate a discharge, and thus, a sustain discharge 120 may occur.

Since the sustain discharge 120 is a strong discharge and the application of an external voltage to the scan electrodes included in the first group continues, the polarity of the wall discharges accumulated in the scan electrodes included in the first group may change due to the sustain discharge 120. In addition, since the voltage of the address electrodes is relatively low, the wall charges accumulated in the address electrodes may be transformed into positive wall charges.

The number of pulses applied to the scan electrodes included in the first group during the setting period Pₜ may be different from the number of pulses applied to the sustain electrodes during the setting period Pₜ. In this case, the setting period Pₜ may also include a fourth period P₄ following the third period P₃. During the fourth period P₄, a number of positive pulses may be applied to the sustain electrodes. The fourth period P₄ may be longer than the first period. The third and fourth periods P₃ and P₄ may be long enough to cause a sustain discharge. More specifically, the third and fourth periods P₃ and P₄ may be at least 5 μs long.

FIG. 11(e) illustrates a diagram showing the wall-charge state of the scan electrodes included in the first group during the fourth period P₄. The wall-charge state of the scan electrodes included in the first group during the fourth period P₄ may be almost the same as the wall-charge state shown in FIG. 9(d) except that a positive voltage is applied to the sustain electrodes while applying no voltage to the scan electrodes and the address electrodes.

The second subfield 2SF shown in FIG. 9 may also include the second set-down period during which a second set-down signal whose voltage gradually decreases is applied to each of the first and second groups. The slope of the second set-down signal applied to the first group may be greater than the slope of the second set-down signal applied to the second group. Since an address operation is performed on the second group during the second scan period, it is possible to uniformly maintain an appropriate wall-charge state for causing an address discharge by applying a second set-down signal whose voltage gradually decreases before the arrival of the second scan period. In this case, the voltage of the scan electrodes included in the first group may be gradually reduced by floating the scan electrodes included in the first group.

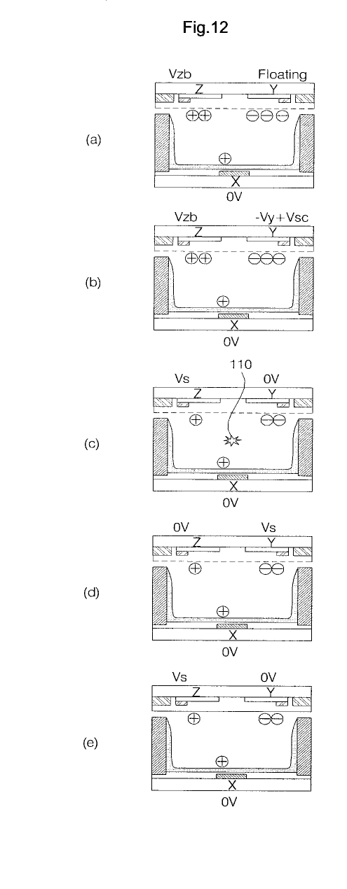

A driving signal applied to the scan electrodes included in the second group will hereinafter be described in detail with reference to FIGS. 12(a) through 12(e). FIGS. 12(a) through 12(e) illustrate diagrams showing variations in the wall-charge state of the scan electrodes included in the second group during the second subfield 2SF shown in FIG. 9.

Referring to FIG. 12(a), during the first set-down period, the voltages of the scan electrodes included in the second group may be gradually reduced by floating the scan electrodes included in the second group. The slope of the voltage of the scan electrodes included in the second group during the first set-down period may be less than the slope of the voltage of the scan electrodes included in the first group during the first set-down period. Thus, no discharge may occur in the scan electrodes included in the first group. Accordingly, the wall-charge state of the scan electrodes included in the first group during the first set-down period may be almost the same as the wall-charge state shown in FIG. 10, i.e., the wall-charge state of the scan electrodes included in the first group during the first setup period.

During the reset period, negative charges for causing an address discharge may be formed in the scan electrodes included in the first group. During the first scan period, a negative scan signal may be sequentially applied to the scan electrodes included in the first group while maintaining the voltage of the scan electrodes included in the first group at a scan bias voltage, and at the same time, a positive data signal Va may be applied to the address electrodes. As a result, an address discharge may occur.

However, neither a scan signal nor a data signal may be applied to the scan electrodes included in the second group. Thus, no address discharge may occur in the scan electrodes included in the second group. Therefore, the wall-charge state of the scan electrodes included in the second group may become as shown in FIG. 12(b). Some of the wall charges in the scan electrodes included in the second group may be lost over time.

During the first period P₁, no voltage may be applied to the scan electrodes and the address electrodes, whereas a positive first voltage may be applied to the sustain electrodes. The positive first voltage may be a sustain voltage. In this case, an additional power supply circuit is unnecessary, and thus, it is easy to design circuitry. During the first period P₁, a weak discharge 110 may occur in the scan electrodes included in the second group due to the voltage applied to the sustain electrodes and a wall-charge voltage. FIG. 12(c) illustrates a diagram showing the wall-charge state of the scan electrodes included in the second group during the first period P₁.

If no discharge occurs in the scan electrodes included in the second group until the arrival of the setting period Pₜ, it may become almost impossible to maintain the same wall-charge state as that during the reset period until the arrival of the second scan period without any wall charge loss due to a long interval between the reset period and the second scan period. Thus, an address discharge operation for the scan electrodes included in the second group may become unstable due to a shortage of wall charges.

However, if the weak discharge 110 is induced to occur in the scan electrodes included in the second group, as described above, almost the same wall-charge state as that shown in FIG. 10 or 11(a) may be uniformly maintained until the arrival of the second set-down period or even the scan period for causing an address discharge in the scan electrodes included in the second group. Therefore, it is possible to prevent the occurrence of an address misdischarge.

In this case, since it is undesirable to induce too strong a discharge or induce a discharge for too long in terms of timing margin, the first period P₁ may be set to be shorter than the third period P₃. More specifically, the first period P₁ may be about 1 μs long.

FIG. 12(d) illustrates a diagram showing the wall-charge state of the scan electrodes included in the second group during the third period P₃, and FIG. 12(e) illustrates a diagram showing the wall-charge state of the scan electrodes included in the second group during the fourth period P₄. Referring to FIG. 12(d), during the third period P₃, a positive voltage may be applied to the scan electrodes included in the second group while applying no voltage to the sustain electrodes. On the other hand, referring to 12(e), during the fourth period P₄, the positive voltage may be applied to the sustain electrodes while applying no voltage to the scan electrodes included in the second group. In short, during the third or fourth period P₃ or P₄, no discharge may occur in the scan electrodes included in the second group. The wall-charge state of the scan electrodes included in the second group during a time period following the second scan period may be similar to the wall-charge state of the scan electrodes included in the first group during a time period following the first scan period.

As described above, the exemplary embodiments of FIGS. 5 through 12(e) can be applied to some of a plurality of subfields of a frame, and particularly, at least one of the subfields subsequent to a first subfield.

According to the present invention, it is possible to drive a PDP at high speed by dividing a plurality of scan electrodes into a plurality of groups and driving the scan electrodes in units of the groups.

Conventionally, in a group of scan electrodes in which an address operation is performed at a relatively late stage of an address period, no discharge may occur until the occurrence of an address discharge, and some wall charges may be lost over time. Thus, an address misdischarge may occur due to such wall-charge loss. However, according to the present invention, a weak discharge may be induced to occur during a setting period, and thus, it is possible to provide a uniform distribution of wall charges even in a group of scan electrodes where an address operation is performed at a late stage of an address period and thus to reduce the probability of occurrence of an address misdischarge. Therefore, it is possible to improve display quality.

In addition, it is possible to reduce the length of a setup period by applying a narrow-width pulse to a plurality of scan electrodes and a bias voltage to a plurality of sustain electrodes during a first setup period.

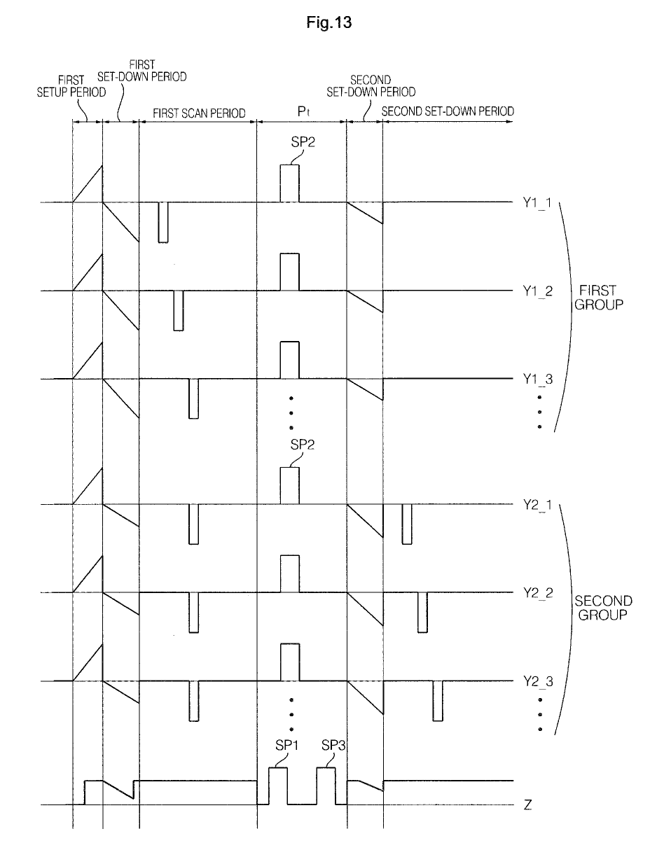

FIG. 13 illustrates a timing diagram of a plurality of driving signals for driving a plasma display device according to another exemplary embodiment of the present invention, in which a plurality of scan electrodes of a PDP are divided into two groups and are driven in units of the two groups. Referring to FIG. 13, a plurality of scan electrodes may be divided into two groups: a first group including a number of upper scan electrodes disposed in the upper half of a PDP and a second group including a number of lower scan electrodes disposed in the lower half of the PDP. A scan signal may be sequentially applied to the scan electrodes included in the first group. Thereafter, a scan signal may be sequentially applied to the scan electrodes included in the second group. During a setting period Pₜ, a pulse may be applied to a plurality of sustain electrodes earlier than to the scan electrodes. The detailed descriptions of the exemplary embodiments of FIGS. 5 through 12(e) can be applied to the exemplary embodiment of FIG. 13.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A plasma display device comprising:
a plasma display panel (PDP) including an upper substrate having a plurality of scan electrodes and a plurality of sustain electrodes formed thereon and a lower substrate having a plurality of address electrodes formed thereon; and
a driving unit applying a number of driving signals to the scan electrodes, the sustain electrodes and the address electrodes,
wherein the scan electrodes are divided into two or more groups including first and second groups, at least one of a plurality of subfields includes a first scan period during which a scan signal is applied to the scan electrodes included in the first group, a second scan period during which a scan signal is applied to the scan electrodes included in the second group, and a setting period between the first and second scan periods, and the time of application of a first pulse applied to the sustain electrodes for the first time during the setting period is earlier than the time of application of a second pulse applied to the scan electrodes for the first time during the setting period.

2. The plasma display device of claim 1, wherein the first group includes a number of even-numbered scan electrodes and the second group includes a number of odd-numbered scan electrodes.

3. The plasma display device of claim 1, wherein the first group includes a number of upper scan electrodes disposed in the upper half of the PDP and the second group includes a number of lower scan electrodes disposed in the lower half of the PDP.

4. The plasma display device of claim 1, wherein the number of pulses applied to the sustain electrodes during the setting period is different from the number of pulses applied to the scan electrodes during the setting period.

5. The plasma display device of claim 4, wherein the number of pulses applied to the sustain electrodes during the setting period is one greater than the number of pulses applied to the scan electrodes during the setting period.

6. The plasma display device of claim 1, wherein the duration of application of the first pulse partially overlaps with the duration of application of the second pulse.

7. The plasma display device of claim 1, wherein, after the setting period, the driving unit applies a first signal whose voltage gradually decreases to the scan electrodes included in the first group and a second signal whose voltage gradually decreases to the scan electrodes included in the second groups.

8. The plasma display device of claim 7, wherein the slope of the first signal is greater than the slope of the second signal.

9. The plasma display device of claim 7, wherein the scan electrodes included in the first group are floated during the application of the first signal.

10. The plasma display device of claim 1, wherein the at least one subfield further includes a reset period during which a reset signal is applied to the scan electrodes, the reset period includes a first setup period during which the voltage of the reset signal gradually increases and a first set-down period during which the voltage of the reset signal gradually decreases to a negative voltage, the driving unit applies a bias voltage to the sustain electrodes and the duration of application of the bias voltage at least partially overlaps with the duration of application of the reset signal.

11. The plasma display device of claim 1, wherein the at least one subfield further includes a reset period during which a reset signal is applied to the scan electrodes, the reset period includes a first setup period during which the reset signal is maintained at a positive voltage and a first set-down period during which the voltage of the reset signal gradually decreases to a negative voltage, the driving unit applies a bias voltage to the sustain electrodes and the duration of application of the bias voltage at least partially overlaps with the duration of application of the reset signal.

12. The plasma display device of claim 11, wherein, during the first set-down period, the scan electrodes included in the second group are floated.

13. The plasma display device of claim 11, wherein the absolute value of a minimum voltage of the voltages of the scan electrodes included in the first group during the first set-down period is greater than the absolute value of a minimum voltage of the voltages of the scan electrodes included in the second group during the first set-down period.

14. The plasma display device of claim 1, wherein a maximum voltage detected during a setup period of a first subfield is higher than a maximum voltage detected during a setup period of a second subfield.

15. A plasma display device comprising:
a PDP including an upper substrate having a plurality of scan electrodes and a plurality of sustain electrodes formed thereon and a lower substrate having a plurality of address electrodes formed thereon; and
a driving unit applying a number of driving signals to the scan electrodes, the sustain electrodes and the address electrodes,
wherein the scan electrodes are divided into two or more groups including first and second groups, at least one of a plurality of subfields includes a first scan period during which a scan signal is applied to the scan electrodes included in the first group, a second scan period during which a scan signal is applied to the scan electrodes included in the second group, and a setting period between the first and second scan periods, and the setting period includes a first period during which a first voltage is applied to the sustain electrodes, a second period during the sustain electrodes are maintained at the first voltage and a second voltage is applied to the scan electrodes, and a third period during which the scan electrodes are maintained at the second voltage.

16. The plasma display device of claim 15, wherein the first or second voltage is a sustain voltage.

17. The plasma display device of claim 15, wherein the first period is shorter than the third period.

18. The plasma display device of claim 15, wherein, after the setting period, the driving unit applies a first signal whose voltage gradually decreases to the scan electrodes included in the first group and a second signal whose voltage gradually decreases to the scan electrodes included in the second groups.

19. The plasma display device of claim 15, wherein the setting period further includes a fourth period during which a positive pulse is applied to the sustain electrodes.

20. The plasma display device of claim 19, wherein the fourth period is longer than the first period.
